(19) United States
(12) Patent Application Publication
(10) Pub. No.: US 2019/0005604 A1
(43) Pub. Date: Jan. 3, 2019

(54) BIN STREAMOUT PREEMPTION IN A GRAPHICS PROCESSING PIPELINE

(71) Applicant: Advanced Micro Devices, Inc., Sunnyvale, CA (US)

(72) Inventors: Anirudh R. ACHARYA, San Diego, CA (US); Michael MANTOR, Orlando, FL (US); Vineet GOEL, San Diego, CA (US); Swapnil SAKHARSHETE, San Diego, CA (US)

(21) Appl. No.: 15/639,980

(22) Filed: Jun. 30, 2017

(51) Int. Cl. G06T 1/20; G06T 15/00; G06T 17/10

(52) U.S. Cl. CPC G06T 1/20; G06T 17/10; G06T 15/005

(57) ABSTRACT

A stage of a graphics pipeline in a graphics processing unit (GPU) detects an interrupt concurrently with the stage processing primitives in a first bin that represents a first portion of a first frame generated by a first application. The stage forwards a completed portion of the primitives to a subsequent stage of the graphics pipeline in response to the interrupt. The stage diverts a second bin that represents a second portion of the first frame from the stage to a memory in response to the interrupt. The stage processes primitives in a third bin that represents a portion of a second frame generated by a second application subsequent to diverting the second bin to the memory. The stage can then retrieve the second bin from the memory in response to the stage completing processing of the primitives in the third bin for additional processing.

### BACKGROUND

A conventional graphics pipeline for processing three-dimensional (3-D) graphics is formed of a sequence of programmable shaders and fixed-function hardware blocks. Software applications can generate frames for rendering by the graphics pipeline and provide the frames to a command processor at the front end of the graphics pipeline. The frames are subdivided into primitives such as triangles or patches that represent portions of objects in the image represented by the frame. For example, the primitives can represent portions of a 3-D model of an object that is visible in the frame. A graphics engine processes each primitive in response to a draw call and provides the process primitives to a shader subsystem, which performs shading of the primitives. The graphics pipeline also includes a rasterizer to perform rasterization of the primitive and a binner to group the primitives into bins that are associated with different portions of the frame. The bins of primitives are then provided to the shader subsystem for additional shading prior to being rendered on a display. The shaders or fixed function hardware blocks in the graphics pipeline can concurrently process different primitives or bins of the same frame. For example, the graphics engine, the shader subsystem, rasterizer, and binner can concurrently process different primitives that represent a portion of the frame.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that includes graphics processing unit (GPU) for creating visual images intended for output to a display according to some embodiments.

FIG. 2 is a block diagram of a graphics pipeline according to some embodiments.

FIG. 3 is a block diagram of snapshots of a graphics pipeline during three time intervals according to some embodiments.

FIG. 4 is a block diagram of a portion of a graphics pipeline according to some embodiments.

FIG. 5 is a flow diagram of a method for selectively diverting primitives or bins to a preemption memory in response to an interrupt according to some embodiments.

FIG. 6 is a flow diagram of a method for retrieving primitives or bins that have been diverted to a preemption memory in response to an interrupt according to some embodiments.

### DETAILED DESCRIPTION

Graphics preemption can be used to interrupt processing of frames generated by one application to allow the graphics pipeline to process frames generated by another application. For example, rendering of images generated by a video game that is being played by a user can be interrupted to display a notification that a phone call has arrived for the user. However, a conventional graphics pipeline must complete processing of all of the primitives or frames that have been submitted to the graphics pipeline for processing by an application before servicing an interrupt to allow the graphics pipeline to begin processing frames for another application. For example, an interrupt can arrive at the graphics pipeline while the graphics engine is processing a first bin of primitives that represent a first portion of a frame, the shader subsystem is processing a second bin of primitives that represent a second portion of the frame, and a stage that includes the rasterizer and binner is processing a third bin of primitives that represent a third portion of the frame. The graphics pipeline must complete processing of the first, second, and third bins of primitives before servicing the interrupt, which increases the latency of conventional graphics preemption techniques.

The latency of graphics preemption in a graphics pipeline can be reduced by configuring the stage that includes the rasterizer and the binner to store information representative of one or more primitives associated with a frame that has been submitted to the graphics pipeline by a first application. The information can include post transform vertex attributes that are used by the rasterizer for rasterization of pixels. The stage stores the information in response to the graphics pipeline receiving an interrupt and prior to shading or rasterizing the primitives in the stage. The information can be stored in a designated region of memory that is referred to as preemption memory. Some embodiments of the stage preempt processing to service interrupts at bin granularity. In that case, the stage completes processing of bins that are received by the stage prior to the interrupt. Information that represents bins that arrive at the stage subsequent to the interrupt is then stored in the preemption memory to free the stage to process bins associated with one or more frames generated by a second application subsequent to the interrupt. Some embodiments of the stage are configured to preempt processing to service interrupts at primitive (or sub-primitive) granularity. In that case, the stage can stop processing a bin after completing processing of a primitive (or a pixel or a number of pixels) in response to the interrupt. The information stored in the preemption memory includes identifiers of the primitives (or pixels) in the current bin that have not yet been processed by the stage. Once the stage has completed processing of the primitives or bins generated by the second application, the stage retrieves the information stored in the preemption memory and resumes processing of the primitives or bins in the frame submitted by the first application.

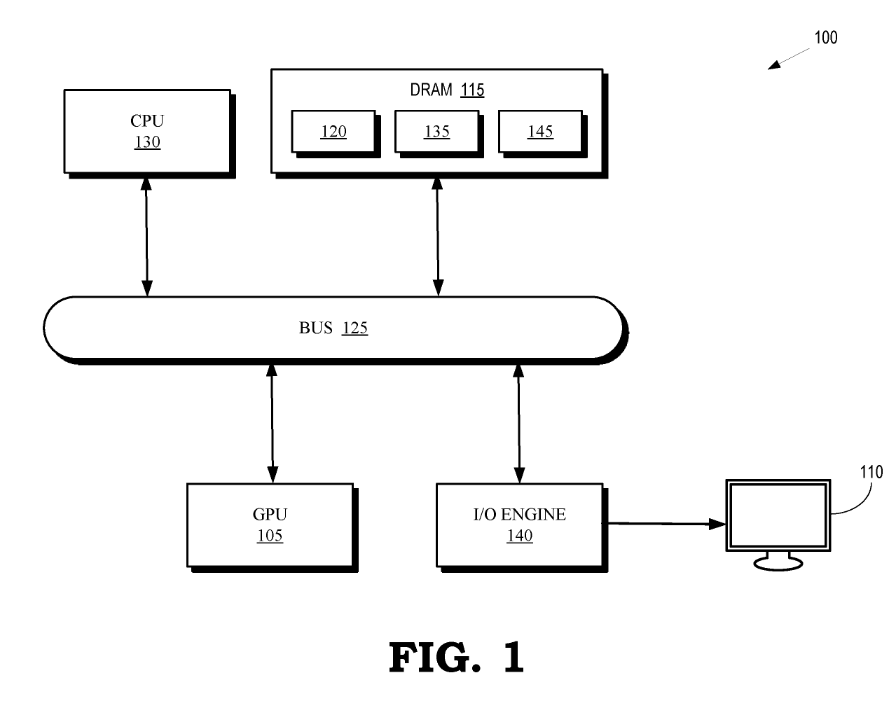

FIG. 1 is a block diagram of a processing system 100 that includes graphics processing unit (GPU) 105 for creating visual images intended for output to a display 110 according to some embodiments. The GPU 105 is coupled to a memory 115. The GPU 105 can execute instructions stored in the memory 115 and the GPU 105 can store information in the memory 115 such as the results of the executed instructions. Some embodiments of the GPU 105 include multiple processor cores (not shown in the interest of clarity) that can independently execute instructions concurrently or in parallel. In the illustrated embodiment, the memory 115 is implemented as a dynamic random access memory (DRAM), which can store a copy 120 of instructions from a program code that is to be executed by the GPU 105. However, the memory 115 can also be implemented using other types of memory including static random access memory (SRAM), nonvolatile RAM, and the like. In the illustrated embodiment, the GPU 105 communicates with the memory 115 over a bus 125. However, some embodiments of the GPU 105 communicate with the memory 115 over a direct connection or via other buses, bridges, switches, routers, and the like.

The processing system 100 also includes a central processing unit (CPU) 130 for executing instructions. Some embodiments of the CPU 130 include multiple processor cores (not shown in the interest of clarity) that can independently execute instructions concurrently or in parallel. The CPU 130 is also connected to the bus 125 and can therefore communicate with the GPU 105 and the memory 115 via the bus 125. The CPU 130 can execute instructions such as program code 135 stored in the memory 115 and the CPU 130 can store information in the memory 115 such as the results of the executed instructions. The CPU 130 is also able to initiate graphics processing by issuing draw calls to the GPU 105.

A draw call is a command that is generated by the CPU 130 and transmitted to the GPU 105 to instruct the GPU 105 render an object in a frame (or a portion of an object). Some embodiments of a draw call include information defining textures, states, shaders, rendering objects, buffers, and the like that are used by the GPU 105 to render the object or portion thereof. The information included in the draw call can be referred to as a state vector that includes state information. The GPU 105 renders the object to produce values of pixels that are provided to the display 110, which uses the pixel values to display an image that represents the rendered object. Some embodiments of the processing system 100 include an input/output (I/O) engine 140 for handling input or output operations associated with the display 110, as well as other elements of the processing system 100 such as keyboards, mice, printers, external disks, and the like. The I/O engine 140 is coupled to the bus 125 so that the I/O engine 140 is able to communicate with the GPU 105, the memory 115, or the CPU 130.

The GPU 105 implements a graphics pipeline (not shown in FIG. 1 in the interest of clarity) that includes multiple stages configured for concurrent processing of different primitives or bins in response to a draw call. For example, stages of the graphics pipeline in the GPU 105 can concurrently process different primitives or bins generated by a first application, such as a video game. The CPU 130 can generate interrupts that indicate that the GPU 105 is to suspend processing of the primitives or bins generated by the first application. The interrupt can be generated in response to a request from a second application to utilize resources of the GPU 105 to process image data generated by the second application for presentation on the display 110. For example, the CPU 130 can generate an interrupt in response to a phone application that is executing in the background on the processing system 100 receiving an incoming call and issuing a request to display a notification to a user playing a video game that is executing on the processing system 100.

In response to receiving the interrupt, the GPU 105 is configured to preempt processing of primitives or bins generated by one application to free resources for processing of primitives or bins generated by the interrupting application. Some embodiments of the GPU 105 are therefore configured to detect interrupts concurrently with processing primitives in a bin that represents a portion of a frame generated by a first application. A stage in the graphics pipeline of the GPU 105 that is processing primitives in the bin, such as a stage that includes a rasterizer or a binner, can continue processing (some or all of) the primitives until processing in the stage is complete. The stage then forwards the completed portion of the primitives to a subsequent stage of the graphics pipeline in response to the interrupt. The state subsequently diverts uncompleted primitives or bins (as well as associated attributes or identifiers in some cases) to a previously allocated portion of the memory 115 that is referred to as a preemption memory 145. The uncompleted primitives/bins can include uncompleted primitives (or pixels) in the bin, subsequently received bins, or subsets of the primitives in the subsequently received bins. The graphics pipeline is then available to process primitives or bins generated by a second application. Once the primitives or bins generated by the second application have been processed in the graphics pipeline, the graphics pipeline can retrieve the uncompleted primitives or bins (as well as any associated attributes or identifiers) from the preemption memory 145 and resume processing of the uncompleted primitives or bins.

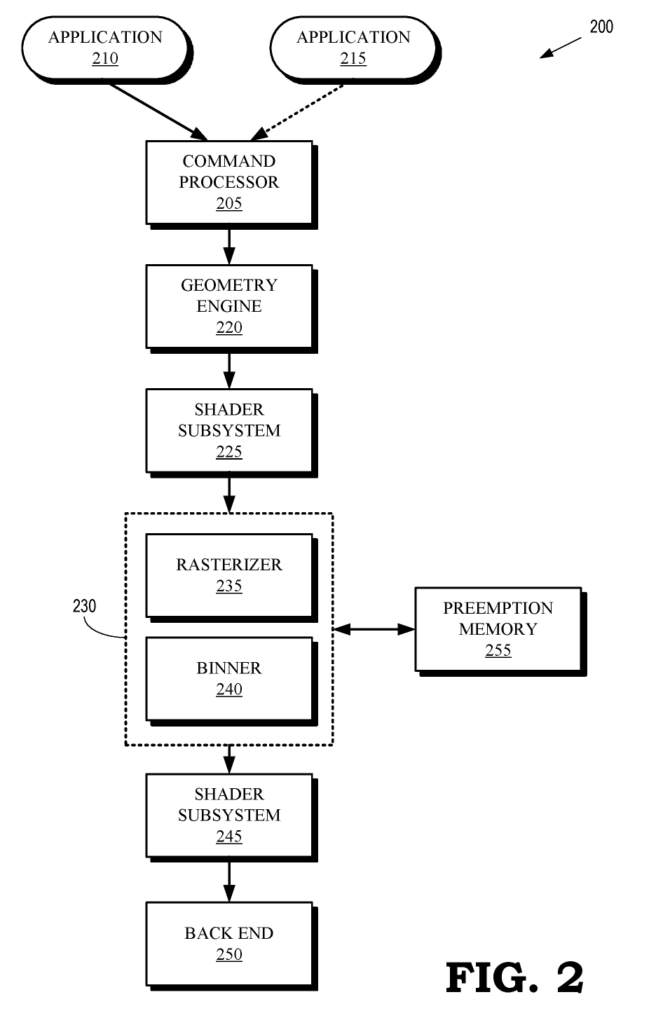

FIG. 2 is a block diagram of a graphics pipeline 200 according to some embodiments. The graphics pipeline 200 is implemented in some embodiments of the GPU 105 shown in FIG. 1. Stages in the graphics pipeline 200 can be implemented as hardware, firmware, or software so that the stages can include a sequence of programmable shaders and fixed-function hardware blocks.

The graphics pipeline 200 includes a command processor 205 that receives commands, e.g., from a processor such as the CPU 130 shown in FIG. 1. The command processor 205 processes the commands and uses the results to control operation of subsequent stages in the graphics pipeline 200. For example, the command processor 205 can issue primitives or bins (and associated state information) for processing by subsequent stages of the graphics pipeline 200 in response to receiving a draw call from a processor. The image data that is processed by the graphics pipeline in response to the draw call can be received from an application 210. The command processor 205 can also detect interrupts and, in response to detecting the interrupt, the command processor 205 can stop or suspend processing of bins or primitives associated with the application 210 and initiate processing of bins of primitives associated with an interrupting application 215, as discussed herein.

A geometry engine 220 performs geometric manipulation of primitives by applying geometric transforms or other operations to the primitives received from the command processor 205. The geometric transforms include transformations of vertices of the primitives into different coordinate systems, e.g., depending on the relative orientation of the object and a camera that represents a user's viewpoint.

The transformed primitives are provided to a shader subsystem 225 that performs shading of the vertices of the primitives that are received from the geometry engine 220. Some embodiments of the shader subsystem 225 include a vertex shader and a hull shader that operate on high order primitives such as patches that represent a 3-D model of a scene. The shader subsystem 225 can also implement a tessellator that receives objects (such as patches) from the hull shader and tessellates the input objects based on tessellation factors provided to the tessellator by the hull shader. Tessellation subdivides input higher-order primitives such as patches into a set of lower-order output primitives that represent finer levels of detail, e.g., as indicated by tessellation factors that specify the granularity of the primitives produced by the tessellation process. The shader subsystem 225 can also implement domain shaders, pixel shaders, and the like.

The graphics pipeline 200 includes a stage 230 that receives the shaded primitives from the shader subsystem 225. Some embodiments of the shader subsystem 225 also provide additional state information associated with the shaded primitives. For example, the shader subsystem 225 can provide post transform vertex attributes for the shaded primitives. Depending on the implementation of the shader subsystem 225, the post transform vertex attributes can be generated by a vertex shading stage, a geometry shader, or a domain shader. The stage 230 includes a rasterizer 235 to perform rasterization of the primitives received from the shader subsystem 225. The rasterizer 235 can use the post transform vertex attributes to perform rasterization of pixels associated with the shaded primitives. The stage 230 also includes a binner 240 to group the received primitives into bins that are associated with different portions of the frame. In the illustrated embodiment, the rasterizer 235 and the binner 240 are integrated into a single stage 230. However, the rasterizer 235 and the binner 240 can be implemented as separate functional blocks in some embodiments.

The stage 230 provides bins including information representing the rasterized primitives to a shader subsystem 245. The information representing the rasterized primitives can include information defining pixels or fragments that are generated by rasterizing primitives. Some embodiments of the shader subsystem 245 include a pixel shader that is configured to shade the pixels or fragments that are received from the stage 230. In some embodiments, the shader subsystems 225, 245 are implemented using a common pool of hardware, firmware, or software resources and can therefore be referred to as a unified shader subsystem. The shader subsystem 245 provides the shaded pixels to a back end module 250 that includes one or more hardware modules configured to perform additional pixel processing on the shaded pixels received from the shader subsystem 245. For example, the back end module 250 can include hardware blocks to perform blend, depth, stencil, or other operations on the shaded pixels.

The stage 230 is able to divert primitives or bins for storage in a preemption memory 255, which can be used to implement some embodiments of the preemption memory 145 shown in FIG. 1. The primitives or bins can be diverted to the preemption memory 255 in response to an interrupt so that primitives or bins that are being processed in stages of the graphics pipeline 200, such as the geometry engine 220, the shader subsystem 225, or the stage 230, can be drained from the graphics pipeline 200 to allow the graphics pipeline 200 to process primitives or bins associated with the interrupting application. For example, the stage 230 can divert primitives or bins associated with the application 210 to the preemption memory 255 to allow the graphics pipeline 200 to process primitives or bins associated with an interrupting application 215. As discussed herein, the information stored in the preemption memory can include state information such as post vertex transform attributes. Once the stage 230 has completed processing of the primitives or bins associated with the interrupting application 215, the stage 230 retrieves the stored information from the preemption memory 255 and continues processing the primitives or bins associated with the application 210.

Some embodiments of the stage 230 selectively divert primitives on a bin-by-bin basis (or bin-level granularity). For example, in response to detecting an interrupt, the stage 230 completes processing of the primitives in a bin that is being processed by the stage 230 when the interrupt is detected. The stage 230 then forwards the information associated with the completed primitives in the bin to the shader subsystem 245. The stage 230 diverts primitives or bins that are subsequently received from the shader subsystem 225 to the preemption memory 255.

Some embodiments of the stage 230 selectively divert primitives on a primitive-by-primitive basis (or primitive-level granularity). For example, in response to detecting the interrupt, the stage 230 completes processing on a subset of the primitives in a bin that are being processed by the stage 230 when the interrupt is detected. The completed primitives are forwarded to the shader subsystem 245, which continues processing the primitives for eventual presentation on a display. A remaining subset of uncompleted primitives in the bin is diverted to the preemption memory 255. For example, information representative of the shaded vertices of the uncompleted primitives, as well as state information such as post vertex transform attributes, are stored in the preemption memory 255. The stage 230 can also store identifiers of the uncompleted primitives in the preemption memory 255. The identifiers can be used to recombine the preempted primitives with the completed primitives that were forwarded to the shader subsystem 245 after the preempted primitives complete processing in the stage 230. For example, the identifiers can be used to reorder the completed primitives in their original order. In some embodiments, the stage 230 can be configured to selectively divert portions of bins on finer levels of granularity, such as groups of pixels, individual pixels, fragments, and the like.

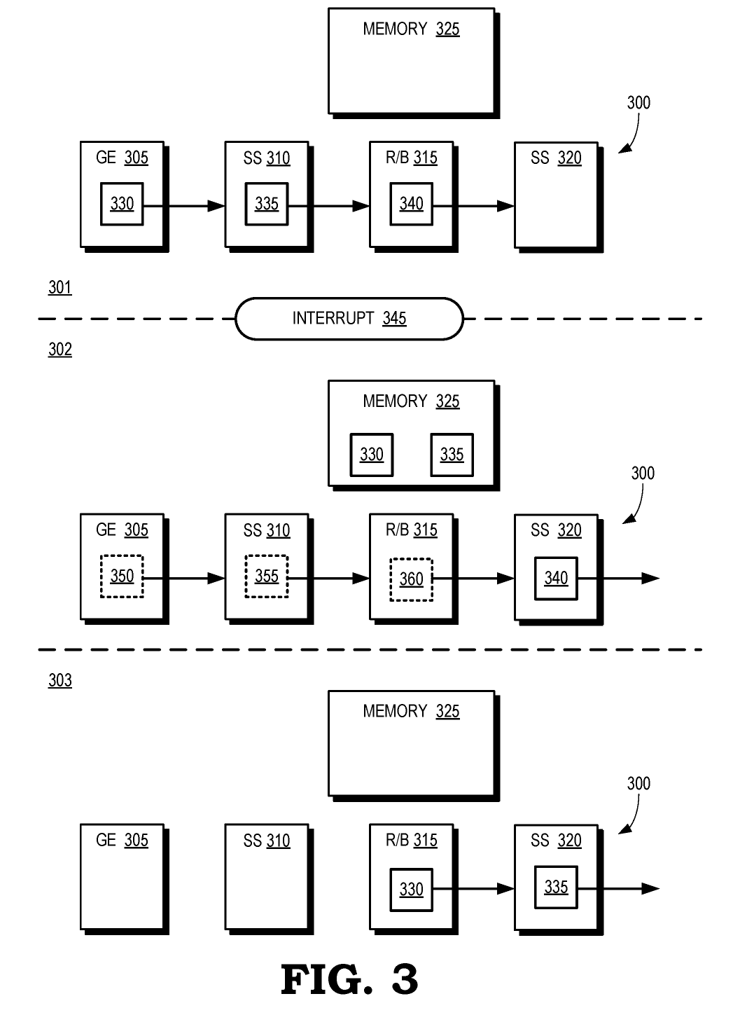

FIG. 3 is a block diagram of snapshots of a graphics pipeline 300 during three time intervals 301, 302, 303 according to some embodiments. The graphics pipeline 300 includes a geometry engine 305, a shader subsystem 310, a rasterizer/binner 315, a shader subsystem 320, and a memory 325 that is used to implement a preemption memory. The graphics pipeline 300 therefore represents some embodiments of the graphics pipeline implemented in the GPU 105 shown in FIG. 1 and the graphics pipeline 200 shown in FIG. 2.

During the time interval 301, the graphics pipeline 300 is processing primitives or bins associated with a first application. For example, the geometry engine 305 is processing primitives associated with a bin 330, the shader subsystem 310 is processing primitives associated with a bin 335, and the rasterizer/binner 315 is processing primitives associated with a bin 340. The bins 330, 335, 340 include primitives that are associated with a frame generated by a first application.

An interrupt 345 is detected at the end of the time interval 301. In response to detecting the interrupt 345, a command processor (such as the command processor 205 shown in FIG. 2) stops issuing primitives or bins associated with the first application for processing in the graphics pipeline 300. The rasterizer/binner 315 completes processing of some or all of the primitives in the bin 340. The completed primitives are forwarded to the shader subsystem 320 and (if only a subset of the primitives in the bin 340 were completed) the uncompleted primitives are diverted to the memory 325. The geometry engine 305 and the shader subsystem 310 complete processing of the primitives associated with bins 330, 335 and provide the processed primitives to the rasterizer/binner 315, which diverts the bin 330, 335 to the memory 325 for storage. As discussed herein, state information such as post shader vertex attributes for the bins 330, 335 is also stored in the memory 325. Thus, during the time interval 302, the bins 330, 335 (and any associated state information or identifiers) are stored in the memory 325. The bin 340, which completed processing in the rasterizer/binner 315 in response to the interrupt 345, is being processed by the shader subsystem 320.

The command processor begins issuing primitives or bins 350, 355, 360 associated with a second application for processing in the graphics pipeline 300 in response to the interrupt. The geometry engine 305 is processing the primitives in the bin 350, the shader subsystem 310 is processing the primitives in the bin 355, and the rasterizer/binner 315 is processing the primitives in the bin 360.

During the time interval 303, the graphics pipeline 300 has completed processing of the bins 350, 355, 360, as well as any other bins associated with the second application. The rasterizer/binner 315 has retrieved the bins 330, 335 (and any associated state information or identifiers) from the memory 325. The rasterizer/binner 315 has completed processing of the primitives in the bin 335 and forwarded the completed bin 335 to the shader subsystem 320. The rasterizer/binner 315 is processing the primitives in the bin 330, which will be forwarded to the shader subsystem 320 once processing of the bin 330 is complete.

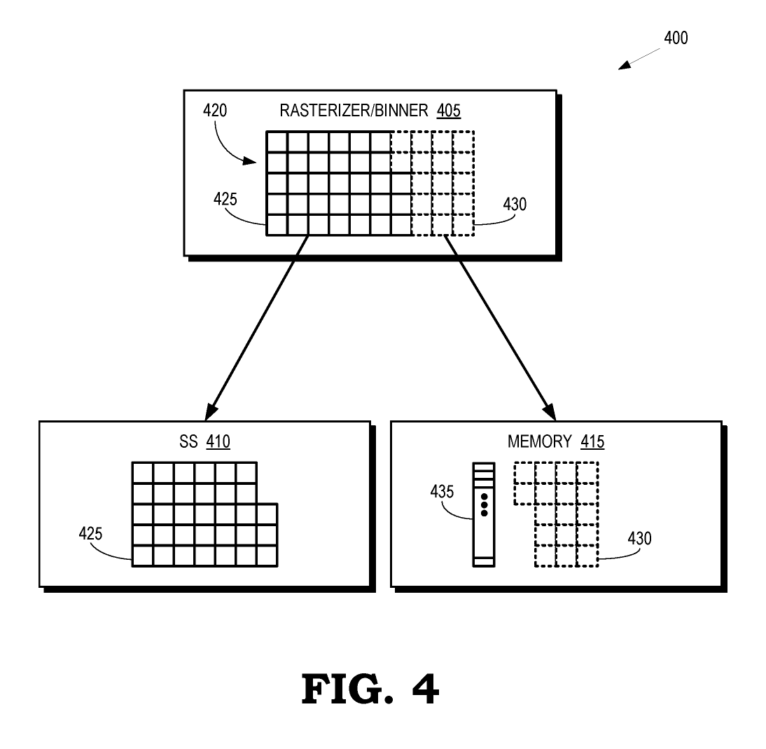

FIG. 4 is a block diagram of a portion 400 of a graphics pipeline according to some embodiments. The portion 400 of the graphics pipeline includes a rasterizer/binner 405, a shader subsystem 410, and a memory 415 that can be allocated as a preemption memory. The portion 400 of the graphics pipeline can therefore be implemented in some embodiments of the graphics pipeline in the GPU 105 shown in FIG. 1, the graphics pipeline 200 shown in FIG. 2 and the graphics pipeline 300 shown in FIG. 3.

The rasterizer/binner 405 is configured to selectively divert subsets of a bin 420 to the shader subsystem 410 or the memory 415. For example, the rasterizer/binner 405 detects an interrupt while the rasterizer/binner 405 is processing the bin 420. In response to detecting the interrupt, the rasterizer/binner 405 completes processing of a first subset 425 of blocks of primitives in the bin 420, as indicated by the solid line blocks. Once complete, the rasterizer/binner 405 forwards the completed first subset 425 to the shader subsystem 410 for subsequent processing, as discussed herein. The rasterizer/binner 405 bypasses processing of second subset 430 of blocks of the primitives in the bin 420, as indicated by the dotted line blocks. The rasterizer/binner 405 does not complete processing of the second subset 430. The (incomplete) second subset 430 is diverted to the memory 415 for storage and subsequent retrieval by the rasterizer/binner 405, as discussed herein. Some embodiments of the rasterizer/binner 405 also store identifiers 435 of the primitives in the second subset 430.

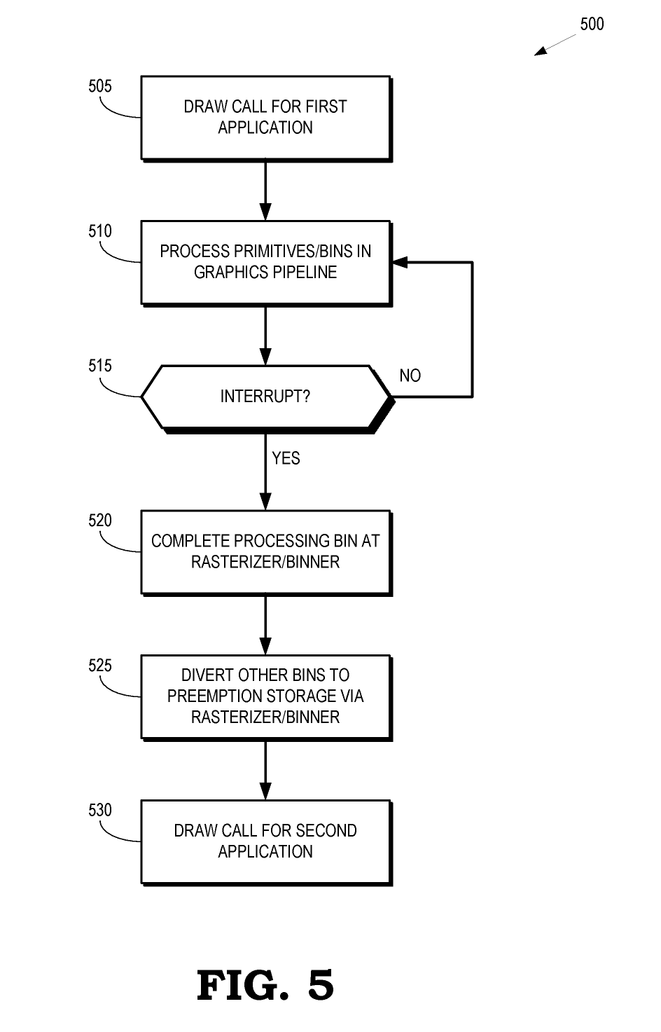

FIG. 5 is a flow diagram of a method 500 for selectively diverting primitives or bins to a preemption memory in response to an interrupt according to some embodiments. The method 500 is implemented in some embodiments of the graphics pipeline in the GPU 105 shown in FIG. 1, the graphics pipeline 200 shown in FIG. 2, the graphics pipeline 300 shown in FIG. 3, and the portion 400 of the graphics pipeline shown in FIG. 4.

At block 505, a processor such as a CPU issues a draw call to instruct the graphics pipeline to initiate processing of a portion of a frame generated by a first application. At block 510, the graphics pipeline processes primitives or bins in the portion of the frame. As discussed herein, different primitives or bins are processed concurrently in different stages of the graphics pipeline including a graphics engine, a shader subsystem, and a rasterizer/binner.

At decision block 515, the graphics pipeline determines whether an interrupt has been detected. As long as no interrupt has been detected, the method 500 flows to block 510 and the graphics pipeline continues processing primitives or bins in the portion of the frame generated by the first application. If an interrupt is detected, the method 500 flows to block 520.

At block 520, the rasterizer/binner in the graphics pipeline completes processing of some or all of the primitives in the bin that is was being processed by the rasterizer/binner when the interrupt was detected. Some embodiments of the rasterizer/binner complete processing of all of the primitives in the bin and then forward the completed bin to the shader subsystem. Some embodiments of the rasterizer/binner complete processing of a subset of the primitives of the bin. The completed subset is forwarded to the shader subsystem and the remaining uncompleted subset of the primitives in the bin is preempted and stored in the preemption memory.

At block 525, the rasterizer/binner receives primitives or bins from upstream stages in the graphics pipeline such as the graphics engine and the shader subsystem. The received bins are associated with the first application and consequently the rasterizer/binner diverts the subsequently received bins to the preemption memory. The bins associated with the first application are therefore drained from the graphics pipeline and any uncompleted primitives or bins are available to be retrieved from the preemption memory to resume processing of the uncompleted primitives or bins.

At block 530, a draw call is issued to instruct the graphics pipeline to initiate processing of primitives or bins in a portion of a frame generated by a second, interrupting application.

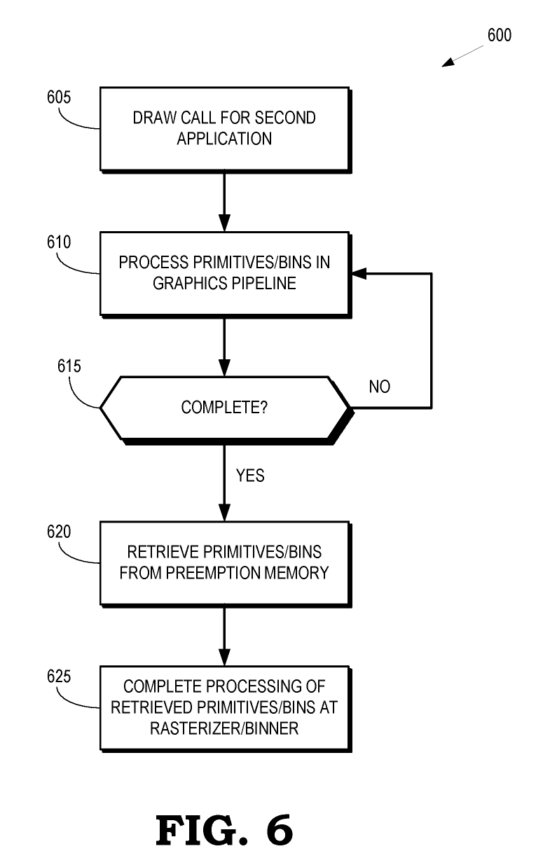

FIG. 6 is a flow diagram of a method 600 for retrieving primitives or bins that have been diverted to a preemption memory in response to an interrupt according to some embodiments. The method 600 is implemented in some embodiments of the graphics pipeline in the GPU 105 shown in FIG. 1, the graphics pipeline 200 shown in FIG. 2, the graphics pipeline 300 shown in FIG. 3, and the portion 400 of the graphics pipeline shown in FIG. 4.

At block 605, a draw call is issued to instruct the graphics pipeline to initiate processing of primitives or bins in a portion of a frame generated by a second application. Prior to the draw call, the graphics pipeline detected an interrupt and suspended processing of primitives or bins in a portion of a frame generated by a first application. The primitives or bins generated by the first application were therefore diverted to a preemption memory.

At block 610, the graphics pipeline processes the primitives or bins in the portion of the frame generated by the second application. At decision block 615, the graphics pipeline determines whether processing of the primitives or bins in the portion of the frame generated by the second application is complete. If not, the method 600 flows to block 610 and the graphics pipeline continues processing the primitives or bins for the second application. Once the graphics pipeline has completed processing the primitives or bins for the second application, the method 600 flows to block 620.

At block 620, a rasterizer/binner in the graphics pipeline retrieves the preempted primitives or bins from the preemption memory. At block 625, the rasterizer/binner completes processing of the retrieved primitives or bins and forwards the completed primitives or bins to a shader subsystem.

In some embodiments, the apparatus and techniques described above are implemented in a system comprising one or more integrated circuit (IC) devices (also referred to as integrated circuit packages or microchips), such as the graphics pipeline described above with reference to FIGS. 1-6. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
detecting, at a stage of a graphics pipeline in a graphics processing unit (GPU), an interrupt concurrently with the stage processing primitives in a first bin that represents a first portion of a first frame generated by a first application;
forwarding a completed portion of the primitives to a subsequent stage of the graphics pipeline in response to the interrupt; and
diverting at least one second bin that represents a second portion of the first frame from the stage to a memory in response to the interrupt.

2. The method of claim 1, wherein forwarding the completed portion of the primitives comprises forwarding the primitives in the first bin in response to completing processing of the primitives in the first bin.

3. The method of claim 1, wherein forwarding the completed portion of the primitives comprises forwarding a first subset of the primitives in the first bin in response to completing processing of the first subset of the primitives.

4. The method of claim 3, further comprising:
diverting a second subset of the primitives in the first bin from the stage to the memory prior to completing processing of the second subset at the stage.

5. The method of claim 4, wherein diverting the second subset of the primitives comprises storing at least one identifier associated with the second subset in the memory.

6. The method of claim 4, wherein the second subset comprises at least one pixel.

7. The method of claim 1, further comprising:
processing, at the stage, primitives in at least one third bin that represents a portion of a second frame generated by a second application subsequent to diverting the at least one second bin to the memory.

8. The method of claim 7, further comprising:
retrieving the at least one second bin from the memory in response to the stage completing processing of the primitives in the at least one third bin;
processing, at the stage, the at least one second bin; and
forwarding completed primitives associated with the at least one second bin to the subsequent stage.

9. An apparatus comprising:
a memory; and
at least one processor configured to implement a stage of a graphics pipeline in a graphics processing unit (GPU), wherein the at least one processor is to:
detect an interrupt concurrently with the stage processing primitives in a first bin that represents a first portion of a first frame generated by a first application;
forward a completed portion of the primitives to a subsequent stage of the graphics pipeline in response to the interrupt; and
divert at least one second bin that represents a second portion of the first frame from the stage to the memory in response to the interrupt.

10. The apparatus of claim 9, wherein the at least one processor is configured to forward the primitives in the first bin in response to completing processing of the primitives in the first bin.

11. The apparatus of claim 9, wherein the at least one processor is configured to forward a first subset of the primitives in the first bin in response to completing processing of the first subset of the primitives.

12. The apparatus of claim 11, wherein the at least one processor is configured to divert a second subset of the primitives in the first bin from the stage to the memory prior to completing processing of the second subset at the stage.

13. The apparatus of claim 12, wherein the at least one processor is configured to store at least one identifier associated with the second subset in the memory.

14. The apparatus of claim 12, wherein the second subset comprises at least one pixel.

15. The apparatus of claim 9, wherein the at least one processor is configured to process, at the stage, primitives in at least one third bin that represents a portion of a second frame generated by a second application subsequent to diverting the at least one second bin to the memory.

16. The apparatus of claim 15, wherein the at least one processor is configured to:
retrieve the at least one second bin from the memory in response to the stage completing processing of the primitives in the at least one third bin;
process, at the stage, the at least one second bin; and
forward completed primitives associated with the at least one second bin to the subsequent stage.

17. A graphics pipeline comprising:
a shader subsystem; and
a pipeline stage comprising a rasterizer and a binner, wherein the pipeline stage is configured to selectively divert portions of bins received from the shader subsystem to a memory in response to detecting an interrupt, wherein the diverted portions of the bins are associated with a first application and the interrupt indicates that bins associated with a second application are available for processing in the graphics pipeline.

18. The graphics pipeline of claim 17, wherein the pipeline stage is configured to selectively divert the portions of the bins by forwarding completed portions of the bins to the shader subsystem and diverting uncompleted portions of the bins to the memory.

19. The graphics pipeline of claim 18, wherein the pipeline stage is configured to store at least one identifier associated with the uncompleted portions in the memory.

20. The graphics pipeline of claim 19, wherein the pipeline stage is configured to:
retrieve the uncompleted portions of the bins from the memory in response to the pipeline stage completing processing of primitives associated with the second application;
process the uncompleted portions of the bins; and
forward completed primitives associated with the uncompleted portions to the shader subsystem.
